(19) United States
(12) Patent Application Publication
(10) Pub. No.: US 2024/0231404 A1
(43) Pub. Date: Jul. 11, 2024

(54) LOW DROPOUT REGULATOR CIRCUIT

(71) Applicant: JADE BIRD DISPLAY (SHANGHAI) LIMITED, SHANGHAI (CN)

(72) Inventor: Hongyun LIU, Shanghai (CN)

(21) Appl. No.: 18/409,688

(22) Filed: Jan. 10, 2024

(30) Foreign Application Priority Data
Jan. 11, 2023 (WO) PCT/CN2023/071795

(51) Int. Cl. G05F 1/575

(52) U.S. Cl. CPC G05F 1/575

(57) ABSTRACT

A low dropout regulator (LDO) circuit includes a following circuit configured to receive a reference voltage and provide an output voltage corresponding to the reference voltage; a regulator circuit configured to provide a regulated output voltage, an output of the following circuit coupled to an input of the regulator circuit to provide the following circuit output voltage as the input voltage of the regulator circuit; and a voltage driving circuit configured to drive an external load, an output of the regulator circuit coupled to an input of the voltage driving circuit, and an output of the voltage driving circuit coupled to the regulator circuit.

### CROSS-REFERENCE TO RELATED APPLICATIONS

The present disclosure claims priority to and the benefits of PCT Application No. PCT/CN2023/071795, filed on Jan. 11, 2023, which is incorporated herein by reference in its entirety.

### TECHNICAL FIELD

The present disclosure generally relates to technology of integrated circuit, and more particularly, to a low dropout regulator (LDO) circuit.

### BACKGROUND

Compared with traditional linear regulators, an LDO is a kind of low dropout linear regulator. Traditional linear regulators require an input voltage to be at least 2V to 3V higher than an output voltage. However, in some situations, such conditions may be too limiting. For example, when converting an input voltage of 5V to an output voltage of 3.3V, a voltage difference between the input and the output is only 1.7V which is less than 2V. As a result, the working conditions of traditional linear regulators are not satisfied. Therefore, LDO-type voltage conversion chips have been developed.

An LDO regulator is a type of power management circuit. The LDO regulator has a lower voltage difference between an input voltage and an output voltage than a traditional linear regulator, thereby improving its usefulness. Generally, an LDO circuit is composed of differential amplifiers, power MOS (Metal-Oxide-Semiconductor) transistors, and resistors. However, if a sharp change in load current occurs during operation, a normal operation of the LDO circuit will be affected.

### SUMMARY OF THE DISCLOSURE

Embodiments of the present disclosure provide a low dropout regulator (LDO) circuit. The circuit includes a following circuit configured to receive a reference voltage and provide an output voltage corresponding to the reference voltage; a regulator circuit configured to provide a regulated output voltage, an output of the following circuit coupled to an input of the regulator circuit to provide the following circuit output voltage as the input voltage of the regulator circuit; and a voltage driving circuit configured to drive an external load, an output of the regulator circuit coupled to an input of the voltage driving circuit, and an output of the voltage driving circuit coupled to the regulator circuit.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary low dropout regulator (LDO) circuit, according to some embodiments of the present disclosure.

FIG. 2 is a schematic diagram of an exemplary LDO circuit, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

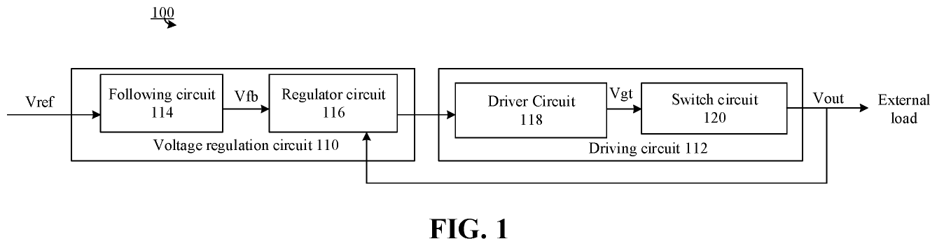

FIG. 1 is a schematic diagram illustrating an exemplary low dropout regulator (LDO) circuit 100, according to some embodiments of the present disclosure. As shown in FIG. 1, LDO circuit 100 includes a voltage regulation circuit 110 and a voltage driving circuit 112 coupled in series. Voltage regulation circuit 110 includes a following circuit 114 and a regulator circuit 116 coupled in series. Voltage driving circuit 112 may further be connectable to an external load, such as an external circuit powered by LDO circuit 100. The output of voltage driving circuit 112 is coupled to voltage regulation circuit 110 to form a feedback loop.

An input of regulator circuit 116 is coupled to an output of following circuit 114, As a result, an output voltage V_{fb} of following circuit 114 is provided as an input voltage to regulator circuit 116. In some embodiments, the output voltage V_{fb} of following circuit 114 corresponds to, or is equal to, an input voltage V_{ref} of following circuit 114. Following circuit 114 isolates the input voltage V_{ref} from the regulator circuit 116, so that the stability of the voltage V_{fb} is improved. Regulator circuit 116 is configured to regulate an output voltage and an input voltage, thereby providing a stable output voltage for voltage driving circuit 112. For example, the output voltage of regulator circuit 116 is configured to provide the output voltage of the regulator circuit based on the output of the following circuit and the output of the voltage driving circuit.

Since an output voltage Vₒᵤₜ of LDO circuit 100 is fed back to voltage regulation circuit 110, the output voltage Vₒᵤₜ can be adjusted by the voltage driving circuit 112 based on the output voltage Vₒᵤₜ. Therefore, when LDO circuit 100 encounters a sharp change in load current during operation, which may result in a fluctuation of Vₒᵤₜ, the Vₒᵤₜ can be quickly fed back to voltage driving circuit 112, so that the output voltage Vₒᵤₜ can be stabilized by adjustment by voltage driving circuit 112.

In some embodiments, the output voltage of regulator circuit 116 can remain the same as the input voltage V_{fb}, i.e., the same as the input voltage V_{ref} of following circuit 114.

In some embodiments, voltage driving circuit 112 further includes a driver circuit 118 and a switch circuit 120 connected in series. Driver circuit 118 is configured to enable switch circuit 120. An output of driver circuit 118, e.g., V_{gt}, is configured as an input to switch circuit 120 to enable switch circuit 120. Switch circuit 120 is coupled to the external load, and configured to provide negative feedback to driver circuit 118. When LDO circuit 100 encounters a sharp change in the load current during operation, a fluctuation of output voltage Vₒᵤₜ occurs, which can be quickly fed back to driver circuit 118, and the output voltage V_{gt} of driver circuit 118 can be adjusted to adjust the working state of switch circuit 120 to stabilize the output of output voltage Vₒᵤₜ.

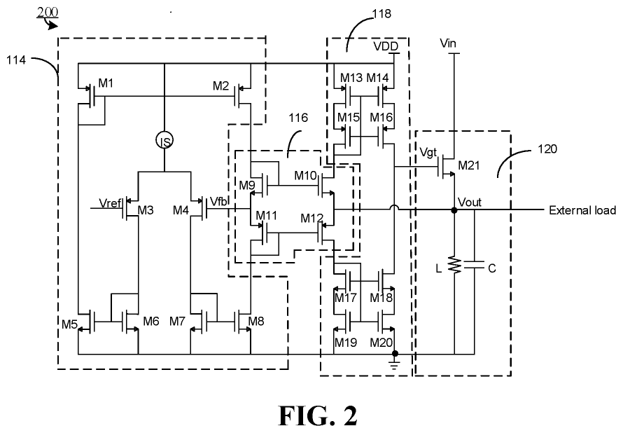

FIG. 2 shows an exemplary LDO circuit 200 according to some embodiments of the present disclosure. LDO circuit 200 represents an exemplary circuit implementation of the above-described LDO circuit 100. LDO circuit 200 includes the above-described following circuit 114, regulator circuit 116, driver circuit 118, and switch circuit 120. Following circuit 114 includes a pair of P-Metal-Oxide-Semiconductor (PMOS) transistors and a controlling circuit. The pair of PMOS transistors includes a PMOS transistor M3 and a PMOS transistor M4. The PMOS transistor M3 and the PMOS transistor M4 are symmetrically arranged, and provide differential inputs for the following circuit 114. The gate of the PMOS transistor M3 is configured as the input of following circuit 114 to receive the voltage V_{ref}. The gate of the PMOS transistor M4 is configured as the output of following circuit 114 to output the voltage V_{fb}. In this example, the following circuit 114 is configured as an operational amplifier to ensure that the gate voltages of M3 and M4 are equal, so V_{fb}=V_{ref}. The voltage V_{fb} is configured as an input voltage to regulator circuit 116. The source of the PMOS transistor M3 and the source of the PMOS transistor M4 are coupled to a working voltage V_{DD} through a current source IS. The drain of the PMOS transistor M3 is connected to the drain of an N-Metal-Oxide-Semiconductor (NMOS) transistor M6, and the drain of the PMOS transistor M4 is connected to the drain of an NMOS transistor M7.

The controlling circuit is configured to control the output voltage of following circuit 114 by controlling the drain of the PMOS transistor M3 and the drain of the PMOS transistor M4.

In some embodiments, the controlling circuit includes a PMOS transistor M1, a PMOS transistor M2, an NMOS transistor M5, an NMOS transistor M6, an NMOS transistor M7, and an NMOS transistor M8. The PMOS transistor M1 and the PMOS transistor M2 are symmetrically arranged. The gate and the drain of the PMOS transistor M1 are connected, and the source of the PMOS transistor M1 and the source of the PMOS transistor M2 are both connected to the working voltage V_{DD}. The drain of the PMOS transistor M1 is connected to the drain of the NMOS transistor M5. The drain of the PMOS transistor M2 is connected to the regulator circuit 116 and is connected to the drain of an NMOS transistor M9.

The NMOS transistor M5 and the NMOS transistor M6 are symmetrically arranged. The gate of the NMOS transistor M5 and the gate of the NMOS transistor M6 are connected. The gate of the NMOS transistor M6 and the drain of the NMOS transistor M6 are connected. The source of the NMOS transistor M5 and the source of the NMOS transistor M6 are both grounded. The NMOS transistor M7 and the NMOS transistor M8 are symmetrically arranged. The gate of the NMOS transistor M7 and the gate of the NMOS transistor M8 are connected. The gate of the NMOS transistor M7 and the drain of the NMOS transistor M7 are connected. The source of the NMOS transistor M7 and the source of the NMOS transistor M8 are both grounded. The drain of the NMOS transistor M6 is connected to the drain of the PMOS transistor M3, and the drain of the NMOS transistor M7 is connected to the drain of the PMOS transistor M4.

Regulator circuit 116 includes the NMOS transistor M9, an NMOS transistor M10, a PMOS transistor M11, and a PMOS transistor M12. The drain of the NMOS transistor M9 is also connected to the drain of the PMOS transistor M2. The drain of the NMOS transistor M9 is connected to the gate of the NMOS transistor M9. The gate of the NMOS transistor M9 is connected to the gate of the NMOS transistor M10. The source of the NMOS transistor M9 is connected to the source of the PMOS transistor M11. The drain of the NMOS transistor M10 is connected to driver circuit 118. The source of the NMOS transistor M10 is connected to the source of the PMOS transistor M12. The gate of the PMOS transistor M11 is connected to the gate of the PMOS transistor M12. The gate of the PMOS transistor M11 and the drain of the PMOS transistor M11 are connected. The drain of the PMOS transistor M11 is also connected to the drain of the NMOS transistor M8. The drain of the PMOS transistor M12 is connected to driver circuit 118.

Driver circuit 118 includes an NMOS transistors group and a PMOS transistors group. The NMOS transistors group and the PMOS transistors group are symmetrically arranged, e.g., symmetrically arranged relative to each other. An input of the NMOS transistors group and an input of the PMOS transistors group are connected to regulator circuit 116. An output of the NMOS transistors group is connected with an output of the PMOS transistors group and further configured as the output of driver circuit 118. The PMOS transistor group includes a PMOS transistor M13, a PMOS transistor M14, a PMOS transistor M15, and a PMOS transistor M16. The NMOS transistor group includes an NMOS transistor M17, an NMOS transistor M18, an NMOS transistor M19, and an NMOS transistor M20. The source of the PMOS transistor M13 and the source of the PMOS transistor M14 are connected to the working voltage VDD. The gate of the PMOS transistor M13 is connected to the gate of the PMOS transistor M14. The drain of the PMOS transistor M13 is connected to the source of the PMOS transistor M15. The drain of the PMOS transistor M14 is connected to the source of the PMOS transistor M16. The gate of the PMOS transistor M13, the gate of the PMOS transistor M14, the gate of the PMOS transistor M15 and the gate of the PMOS transistor M16 are connected together, and further connected to the drain of the PMOS transistor M15. The drain of the PMOS transistor M15 is further connected to the drain of the NMOS transistor M10. The drain of the PMOS transistor M16 is connected to the drain of the NMOS transistor M18. The drain of the NMOS transistor M17 is connected to the drain of the NMOS transistor M12. A connection structure of the NMOS transistor M17, the NMOS transistor M18, the NMOS transistor M19, and the NMOS transistor M20 is configured symmetrically to the connection structure of the PMOS transistor M13, the PMOS transistor M14, the PMOS transistor M15 and the PMOS transistor M16. The source of the NMOS transistor M19 and the source of the NMOS transistor M20 are grounded.

Switch circuit 120 includes a power transistor M21, for example an NMOS transistor M21. The drain of the power transistor M21 is connected to a voltage Vᵢₙ, the gate of the power transistor M21 is connected to the drain of the PMOS transistor M16 and the drain of the NMOS transistor M18 to receive the output of driver circuit 118, i.e., voltage V_{gt}. The source of the power transistor M21 is connectable to the external load. The source of the power transistor M21 is further connected to the sources of the NMOS transistor M10 and the PMOS transistor M12.

When Vₒᵤₜ fed back to regulator circuit 116 changes, voltages at the drain of the NMOS transistor M10 and the drain of the NMOS transistor M12 change accordingly. Therefore, the output of driver circuit 118 V_{gt} changes, which may provide negative feedback to the Vₒᵤₜ to external load. More specifically, when Vₒᵤₜ decreases due to a change of the external load, a voltage at the drain of the NMOS transistor M10 decreases, and a voltage at the gate of PMOS transistor M14 decreases. A voltage at the drain of the PMOS transistor M16 increases and a voltage at the gate of the NMOS transistor M21 V_{gt} increases, thereby providing increasing feedback to the Vₒᵤₜ. Therefore, because of the negative feedback, the Vₒᵤₜ can keep stable when the Vₒᵤₜ deceases due to the change of the external load. When Vₒᵤₜ increases due to a change of the external load, a voltage at the drain of the NMOS transistor M12 increases, and a voltage at the gate of the NMOS transistor M20 increases. A voltage at the drain of the NMOS transistor M18 decreases and a voltage at the gate of the NMOS transistor M21 V_{gt} decreases, thereby providing decreasing feedback to the Vₒᵤₜ. Therefore, because of the negative feedback, the Vₒᵤₜ can keep stable when the Vₒᵤₜ increases due to the change of the external load.

In some embodiments, the switch circuit 120 further includes a voltage-dividing circuit. The voltage-dividing circuit includes a capacitance C and an inductance L connected in parallel. The parallel connected capacitance C and inductance L are connected between the source of the power transistor M21 and the ground.

In this example, the input voltage of following circuit 114 is V_{ref}, and the output voltage of following circuit 114 is V_{fb}. Following circuit 114 is configured to maintain V_{fb}=V_{ref}. As shown in FIG. 2, the input voltage of regulator circuit 116 is V_{fb}, and Vₒᵤₜ is fed back to the output voltage of regulator circuit 116. Four MOS transistors (i.e., M9, M10, M11 and M12) are arranged in pairs. The source of the NMOS transistor M9 and the source of the PMOS transistor M11 are connected. The source of NMOS transistor M10 and the source of the PMOS transistor M12 are connected. Based on the symmetrical configuration, when Vₒᵤₜ changes, an output of driver circuit 118 V_{gt} changes to provide feedback to switch circuit 120 and stabilize the Vₒᵤₜ to external load.

In some embodiments, V_{ref} can be set as 1.2V. V_{DD} is in a range of 2.5V to 3.3V, and Vᵢₙ is in a range of 1.5V to 3.3V.

In feedback LDO circuit 200, the output of driver circuit 118 is configured to drive the switch circuit 120, and the output voltage Vₒᵤₜ of the source of the power transistor M21 is fed back to regulator circuit 116. The output of driver circuit 118 is V_{gt}, and V_{gt} is connected to the gate of the power transistor M21 to provide negative feedback to the output Vₒᵤₜ. When LDO circuit 200 encounters a sharp change in the load current during operation, a fluctuation of Vₒᵤₜ occurs, which can be quickly fed back and the working state of the power transistor M21 can be adjusted to stabilize the output of Vₒᵤₜ.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A low dropout regulator (LDO) circuit, comprising:
a following circuit configured to receive a reference voltage and provide an output voltage corresponding to the reference voltage;
a regulator circuit configured to provide a regulated output voltage, an output of the following circuit coupled to an input of the regulator circuit to provide the following circuit output voltage as an input voltage of the regulator circuit; and
a voltage driving circuit configured to drive an external load, an output of the regulator circuit coupled to an input of the voltage driving circuit, and an output of the voltage driving circuit coupled to the regulator circuit.

2. The circuit according to claim 1, wherein the regulator circuit is configured to provide the output voltage of the regulator circuit based on the output of the following circuit and the output of the voltage driving circuit.

3. The circuit according to claim 2, wherein the regulator circuit comprises a first N-Metal-Oxide-Semiconductor (NMOS) transistor, a first P-Metal-Oxide-Semiconductor (PMOS) transistor, a second NMOS transistor, and a second PMOS transistor; a source of the first NMOS transistor and a source of the first PMOS transistor are connected to be configured as the input of the regulator circuit; a source of the second NMOS transistor and a source of the second PMOS transistor are connected to be configured as the output of the regulator circuit; a gate of the first NMOS transistor and a gate of the second NMOS transistor are coupled; a gate of the first PMOS transistor and a gate of the second PMOS transistor are coupled; the gate of the first NMOS transistor is coupled with a drain of the first NMOS transistor; and the gate of the first PMOS transistor is coupled with a drain of the first PMOS transistor.

4. The circuit according to claim 1, wherein the voltage driving circuit comprises: a driver circuit and a switch circuit; an output of the driver circuit coupled to an input of the switch circuit, and an output of the switch circuit coupled to the regulator circuit.

5. The circuit according to claim 4, wherein the switch circuit further comprises a power transistor, a gate of the power transistor being coupled to the output of the driver circuit, a source of the power transistor for coupling to an external load and coupled with the regulator circuit.

6. The circuit according to claim 5, wherein the switch circuit further comprises a voltage-dividing circuit configured to regulate a feedback, the voltage-dividing circuit coupled between the source of the power transistor and a ground.

7. The circuit according to claim 6, wherein the voltage-dividing circuit further comprises a capacitance and an inductance connected in parallel.

8. The circuit according to claim 4, wherein the driver circuit comprises an NMOS transistors group and a PMOS transistors group, the NMOS transistors group and the PMOS transistors group are symmetrically arranged; an input of the NMOS transistors group and an input of the PMOS transistors group are connected with the regulator circuit; an output of the NMOS transistors group is connected with an output of the PMOS transistors group and further configured as the output of the driver circuit.

9. The circuit according to claim 8, wherein the NMOS transistors group comprises four NMOS transistors, and the PMOS transistors group comprises four PMOS transistors.

10. The circuit according to claim 1, wherein the following circuit further comprises a pair of PMOS transistors and a controlling circuit, wherein the pair of PMOS transistors comprises a first PMOS transistor and a second PMOS transistor; a gate of the first PMOS transistor is configured as the input of the following circuit; a gate of the second PMOS transistor is configured as the output of the following circuit; a source of the first PMOS transistor and a source of the second PMOS transistor are connected with a working voltage; the controlling circuit is configured to control the output voltage of the following circuit by controlling a drain of the first PMOS transistor and a drain of the second PMOS transistor.
